(19) United States
(12) Patent Application Publication
(10) Pub. No.: US 2025/0203022 A1
(43) Pub. Date: Jun. 19, 2025

(54) INSPECTION APPARATUS AND IMAGE FORMING APPARATUS

(71) Applicant: CANON KABUSHIKI KAISHA, Tokyo (JP)

(72) Inventor: KEN OGIHARA, Ibaraki (JP)

(21) Appl. No.: 18/977,456

(22) Filed: Dec. 11, 2024

(30) Foreign Application Priority Data
Dec. 14, 2023 (JP) 2023-211222

(51) Int. Cl. H04N 1/00

(52) U.S. Cl. CPC H04N 1/0009; H04N 1/00015; H04N 1/00031; H04N 1/00045; H04N 1/00082

(57) ABSTRACT

Disclosed is an image forming apparatus including an image forming unit configured to form an image on a sheet based on image data, an inspection unit configured to inspect an image formed on a sheet, a memory configured to store an inspection result inspected by the inspection unit, and a controller configured to execute main printing for controlling the image forming unit to form an image based on the image data, or test printing for controlling the image forming unit to form an image based on only a part of the image data, wherein a first inspection result obtained by performing the test printing is automatically deleted, and a second inspection result obtained by performing the main printing is not automatically deleted.

### BACKGROUND OF THE INVENTION

### Field of the Invention

The present disclosure relates to an image forming apparatus having a printing inspection function of performing a quality inspection of an image printed on a sheet.

### Description of the Related Art

An image forming apparatus generates a printed matter by printing an image on a sheet based on image data representing an image to be printed. Especially the image forming apparatus used at sites of commercial printing, large number of copies or large number of pages may be printed at once. In US 2021/0365219, there is disclosed a method of executing test printing for printing only a specific page before main printing. A printing inspection apparatus inspects whether or not an image printed on a sheet by an image forming apparatus has been formed as instructed by the image data.

In a printing inspection apparatus, image data is set as reference data, scan data obtained by reading an image printed on a sheet through use of a sensor such as a scanner is set as inspection image data, and the image data and the scan data are compared to each other. The printing inspection apparatus determines print quality of a printed matter based on the degree of agreement between the reference data and the inspection image data. The printing inspection apparatus executes a printing inspection in accordance with settings, such as an inspection region and an inspection intensity, which are provided in advance by the user. After executing printing inspection, test result data is stored in an image forming apparatus. This applies to both main printing and test printing.

As to the test printing, in almost all cases, inspection result data stored in the image forming apparatus after the test printing is unnecessary. However, in a case where the inspection result data is not deleted and is retained, it occupies a memory in the image forming apparatus, and there is a risk that the available memory capacity will decrease. US 2021/0365219 does not disclose the available memory amount of the image forming apparatus. Japanese Patent Application Laid-open No. 2021-045866 discloses a technique that is used when the available memory capacity is decreased as above. In this technique, when the free memory amount is decreased, the reference data is not stored, but an original image and the inspection image data is compared to perform the printing inspection.

However, Japanese Patent Application Laid-open No. 2021-045866 is directed to a technique which is used in a case where the memory capacity for storing the reference data is decreased in the memory inside the image forming apparatus.

### SUMMARY OF THE INVENTION

An inspection apparatus according to the present disclosure includes an inspection unit configured to inspect an image formed on a sheet, a memory configured to store an inspection result inspected by the inspection unit, and a setting unit configured to set a condition for automatically deleting the inspection result.

An image forming apparatus according to the present disclosure includes an image forming unit configured to form an image on a sheet based on image data, an inspection unit configured to inspect an image formed on a sheet, a memory configured to store an inspection result inspected by the inspection unit, and a controller configured to execute main printing for controlling the image forming unit to form an image based on the image data, or test printing for controlling the image forming unit to form an image based on only a part of the image data, wherein a first inspection result obtained by performing the test printing is automatically deleted, and a second inspection result obtained by performing the main printing is not automatically deleted.

Further features of the present invention will become apparent from the following description of exemplary embodiments (with reference to the attached drawings).

### BRIEF DESCRIPTION OF THE DRAWINGS

FIG. 1 is a configuration diagram of an image forming system.

FIG. 2 is a configuration diagram of a controller.

FIG. 3 is a configuration diagram of an inspection controller.

FIG. 4 is an explanatory view of a printing setting screen.

FIG. 5 is an explanatory view of an inspection setting screen.

FIG. 6 is an explanatory view of a deletion setting screen.

FIG. 7 is an explanatory view of the operation screen in a case where an operation is temporarily stopped.

FIG. 8A is an explanatory view of the operation screen during a main printing inspection.

FIG. 8B is an explanatory view of the operation screen during a test printing inspection.

FIG. 9 is a flowchart illustrating an inspection printing process.

FIG. 10 is a flow chart representing a deletion process to delete an inspection result data.

### DESCRIPTION OF THE EMBODIMENTS

Now, embodiments of the present disclosure are described with reference to the accompanying drawings. Unless otherwise specified, the following embodiments can be freely combined. Further, those embodiments and modification examples thereof do not limit the disclosure according to the appended claims, and not all combinations of features described in the embodiments are necessarily essential to solving means for the disclosure.

### Configuration of Printing System

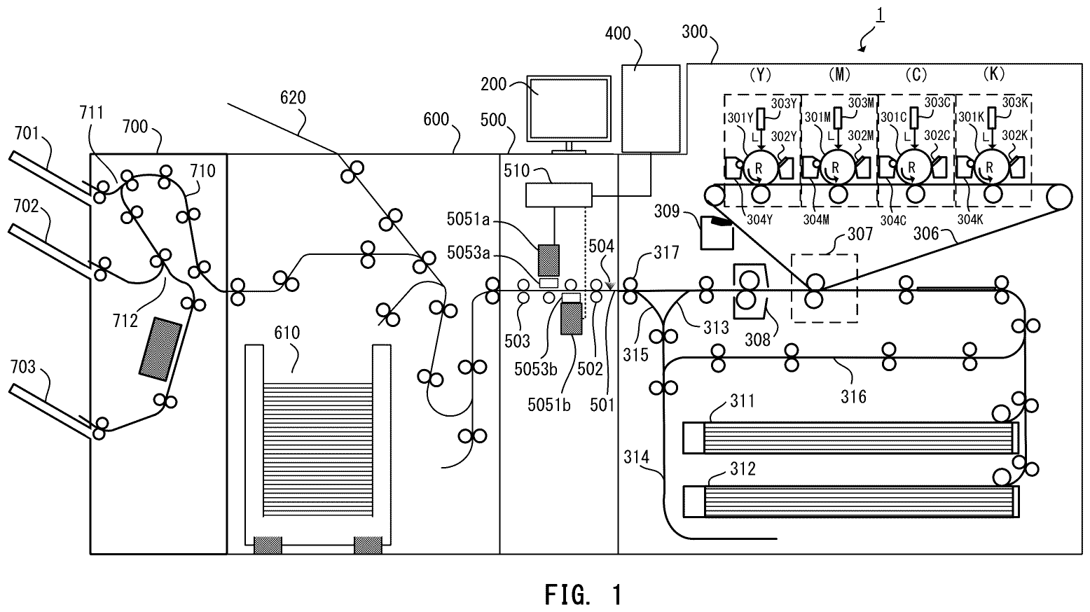

FIG. 1 is a configuration diagram of an image forming system including a printing inspection apparatus according to an embodiment of the present disclosure. An image forming system 1 includes an operating device 200 serving as an operating unit, a printer 300 serving as an image forming unit, a controller 400 serving as a control unit, an inspection apparatus 500 serving as an image inspection unit, a stacker 600, and a finisher 700 serving as a post-processor.

The operating device 200 is a user interface provided with an input interface and an output interface. The input interface is, for example, an input key and a touch panel. The output interface is, for example, a display and a speaker. Therefore, the operating device 200 functions as means for presenting information through vision and hearing. The operating device 200 transmits, to the controller 400, an instruction and data that have been input from the input interface. In addition, the operating device 200 outputs information from the output interface in response to an instruction received from the controller 400.

The controller 400 controls operations of the printer 300, the inspection apparatus 500, the stacker 600, and the finisher 700 based on instructions and data that have been input from the operating device 200 or instructions and data that have been acquired from an external apparatus through a network. For example, to perform image formation, the controller 400 transmits an instruction for the image formation to the printer 300. Details of the controller 400 are described later.

### Printer

The printer 300 in the first embodiment is a color image forming apparatus that prints a color image on a sheet, and functions as printing means. The printer 300 includes image forming units Y, M, C, and K, an intermediate transfer member 306, a transfer unit 307, a fixing device 308, sheet feeding cassettes 311 and 312, and a feeding mechanism for the sheet. The image forming unit Y forms an image of yellow (Y). The image forming unit M forms an image of magenta (M). The image forming unit C forms an image of cyan (C). The image forming unit K forms an image of black (K). The images of the respective colors formed by the image forming units Y, M, C, and K are transferred onto the intermediate transfer member 306 in a superimposed manner. The transfer unit 307 transfers the image borne on the intermediate transfer member 306 onto the sheet. The fixing device 308 fixes, to the sheet, the image transferred onto the sheet. The respective image forming units Y, M, C, and K have the same configuration, and form the images by the same operation. The following description is directed to a configuration of the image forming unit Y, and descriptions of configurations of the image forming units M, C, and K are omitted.

The image forming unit Y includes a photosensitive drum 301Y, a charger 302Y, an exposure device 303Y, and a developing device 304Y. The photosensitive drum 301Y is a drum-shaped photosensitive member including a photosensitive layer on a surface thereof. During an operation, the photosensitive drum 301Y is rotated in a direction indicated by an arrow R about a drum axis. The charger 302Y uniformly charges the surface of the photosensitive drum 301Y being rotated. The exposure device 303Y acquires image data representing an image of yellow from the controller 400, and emits and outputs a laser beam in accordance with the image data. The laser beam output from the exposure device 303Y scans the charged surface of the photosensitive drum 301Y in a drum axis direction.

The laser light scans the surface of the photosensitive drum 301Y being rotated, to thereby form an electrostatic latent image corresponding to the image data of yellow on the surface of the photosensitive drum 301Y. The developing device 304Y stores a yellow developer (e.g., toner), and uses the developer to develop the electrostatic latent image formed on the photosensitive drum 301Y. Thus, a yellow image is formed on the surface of the photosensitive drum 301Y. The developing device 304Y is configured so that a developer can be constantly supplied thereto from a toner cartridge (not shown).

In the same manner, a magenta image is formed on a photosensitive drum 301M of the image forming unit M. A cyan image is formed on a photosensitive drum 301C of the image forming unit C. A black image is formed on a photosensitive drum 301K of the image forming unit K. The intermediate transfer member 306 is an endless belt member, and is rotated in a clockwise direction in FIG. 1. The intermediate transfer member 306 is in contact with the respective photosensitive drums 301Y, 301M, 301C, and 301K. In accordance with the rotation of the intermediate transfer member 306, the images of the respective colors are transferred from the respective photosensitive drums 301Y, 301M, 301C, and 301K in order so as to be superimposed one on another. Thus, a full-color image is formed on the intermediate transfer member 306. The intermediate transfer member 306 conveys the full-color image borne thereon to the transfer unit 307 by being rotated.

Sheets are stored in each of the sheet feeding cassettes 311 and 312, and are conveyed from the sheet feeding cassettes 311 and 312 to the transfer unit 307 by the feeding mechanism. A sheet is conveyed in accordance with a timing at which the image borne on the intermediate transfer member 306 is conveyed to the transfer unit 307. The transfer unit 307 transfers the image from the intermediate transfer member 306 onto the sheet. A cleaner 309 is arranged on a downstream side of the transfer unit 307 in a rotation direction of the intermediate transfer member 306. The cleaner 309 removes a developer remaining on the intermediate transfer member 306 after the transfer.

The sheet onto which the image has been transferred is conveyed from the transfer unit 307 to the fixing device 308. The fixing device 308 includes a heater and a pressure roller. The fixing device 308 uses heat from the heater and pressure from the pressure roller to melt the image and fix the image to the sheet.

Conveying paths 313, 314, and 315, a duplex conveying path 316, and discharge rollers 317 are provided on a downstream side of the fixing device 308 in a conveying direction of the sheet. The sheet that has passed through the fixing device 308 is temporarily conveyed from the conveying path 313 to the conveying path 314. After a trailing end of the sheet has passed through the conveying path 313, the conveying direction is reversed to convey the sheet from the conveying path 315 to the discharge rollers 317. With such conveyance, the sheet is discharged from the printer 300 by the discharge rollers 317 with an image-formed side facing downward (face down). A printed matter, which is the sheet that has been subjected to the image formation and discharged from the printer 300 by the discharge rollers 317, is passed over to the inspection apparatus 500.

When duplex printing is to be performed on the sheet, the sheet conveyed to the conveying path 314 is conveyed to the duplex conveying path 316 after the trailing end has passed through the conveying path 313. The sheet is conveyed again to the transfer unit 307 through the duplex conveying path 316. Due to the passage through the duplex conveying path 316, a side of the sheet on which the image has been formed is turned over. The turned-over side is subjected to image transferring processing by the transfer unit 307 and fixing processing by the fixing device 308, to thereby form an image on this side. The sheet having images formed on both sides is discharged as a printed matter from the printer 300 by the discharge rollers 317, and is passed over to the inspection apparatus 500.

### Printing Inspection Apparatus

The inspection apparatus 500 includes a conveying path 501, an inspection controller 510, a first reader 5051a and a second reader 5051b each serving as a reading unit, flow reading glasses 5053a and 5053b, conveying rollers 502 and 503 serving as conveying means, and a sheet detection sensor 504. Under the control of the controller 400, the inspection controller 510 controls the operation of the inspection apparatus 500. Details of the inspection controller 510 are described later. The first reader 5051a and the second reader 5051b are arranged at positions opposed to each other across the conveying path 501. The conveying rollers 502 and 503 convey the printed matter.

The inspection apparatus 500 detects the printed matter conveyed on the conveying path 501 by the sheet detection sensor 504, and the first reader 5051a and the second reader 5051b read the print images. The first reader 5051a and the second reader 5051b transmit reading results of the printed matter to the inspection controller 510. The inspection controller 510 performs a quality inspection of the images printed on the printed matter based on the reading results of the printed matter. The first reader 5051a and the second reader 5051b are arranged so as to be opposed to each other across the conveying path 501, and hence the images printed on both sides of the printed matter are read in one time of conveyance of the printed matter. The printed matter from which the images have been read is conveyed from the inspection apparatus 500 to the stacker 600.

### Stacker and Finisher

The stacker 600 includes a large-capacity tray 610 and a purge tray 620. The stacker 600 discharges a printed matter to any one of the large-capacity tray 610, the finisher 700, and the purge tray 620 based on an instruction received from the controller 400 and the results of the quality inspection performed by the inspection controller 510.

The finisher 700 includes a printed matter conveyor 710 including a plurality of conveying rollers and conveying paths, an upper-stage delivery tray 701, a middle-stage delivery tray 702, and a lower-stage delivery tray 703. The printed matter conveyor 710 includes switching mechanisms 711 and 712 for switching a discharge destination of the printed matter. The finisher 700 takes in printed matters from the stacker 600 in order, and discharges each of the printed matters to any one of the upper-stage delivery tray 701, the middle-stage delivery tray 702, and the lower-stage delivery tray 703 in response to an instruction received from the controller 400. The finisher 700 may be configured to perform post-processing, such as staple processing for binding and stapling a plurality of printed matters, bookbinding processing for the bound printed matters, and cut-off processing for the bound printed matters.

### Controller

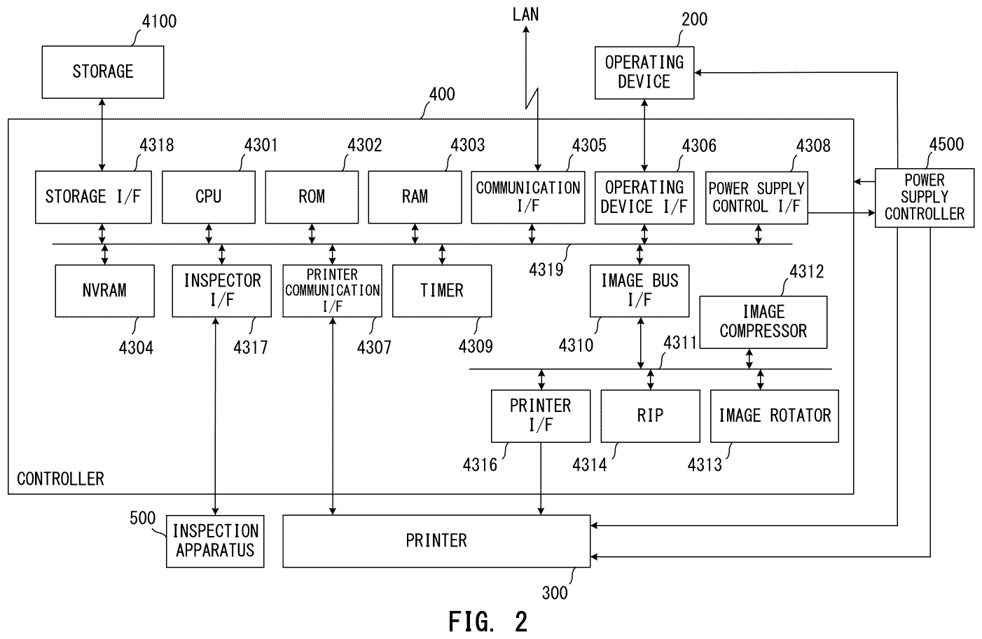

FIG. 2 is a configuration diagram of the controller 400. The storage 4100 serving as a memory unit is a large-capacity storage device, such as a hard disk drive (HDD) or a solid state drive (SSD). In addition to the printer 300, the inspection apparatus 500, and the operating device 200, the controller 400 is connected to a storage 4100 and a power supply controller 4500. As interfaces with the respective components to be connected, the controller 400 includes a storage I/F 4318, an operating device I/F 4306, a power supply control I/F 4308, an inspector I/F 4317, a printer communication I/F 4307, and a printer I/F 4316. The controller 400 also includes a communication I/F 4305 for communicating with an external apparatus through the network. The storage I/F 4318, the operating device I/F 4306, the power supply control I/F 4308, the inspector I/F 4317, the printer communication I/F 4307, and the communication I/F 4305 are connected to a system bus 4319.

The controller 400 includes a central processing unit (CPU) 4301, a read only memory (ROM) 4302, and a random access memory (RAM) 4303. The CPU 4301 executes a computer program stored in the ROM 4302 to control an operation of the image forming system 1. The RAM 4303 provides a work area for the CPU 4301 to execute processing. The RAM 4303 is also used as an image memory for temporarily storing image data and the like. The CPU 4301, the ROM 4302, and the RAM 4303 are also connected to the system bus 4319. A non-volatile RAM (NVRAM) 4304 and a timer 4309 are also connected to the system bus 4319. The NVRAM 4304 stores various parameters for control. The timer 4309 holds a current time, and monitors passage of a set time period.

The operating device I/F 4306 controls communication with the operating device 200. The operating device I/F 4306 receives input of print jobs, commands, and printing settings, which is performed from the operating device 200 to the controller 400, and transmits the input information to the CPU 4301. Under the control of the CPU 4301, the operating device I/F 4306 displays various screens and states of the image forming system 1 on a display (display unit) of the operating device 200. Under the control of the CPU 4301, the printer communication I/F 4307 controls communication with the printer 300. The power supply control I/F 4308 instructs the power supply controller 4500 to supply or stop various kinds of electric power in accordance with a command received from the CPU 4301. The power supply controller 4500 supplies electric power to the printer 300. Under the control of the CPU 4301, the inspector I/F 4317 controls communication with the inspection apparatus 500. Under the control of the CPU 4301, the storage I/F 4318 controls communication with the storage 4100. The storage 4100 is a large-capacity storage device, such as a hard disk drive (HDD) or a solid state drive (SSD).

The communication I/F 4305 is connected to a network such as a local area network (LAN), and performs communication control, such as transmission and reception of an email and inputting and outputting of PDL data from an external apparatus. The communication I/F 4305 also includes an NVRAM (not shown), and holds various parameters relating to communication control, such as a MAC address.

The system bus 4319 is connected to an Image Bus 4311 through an Image Bus I/F 4310. The Image Bus I/F 4310 is a bridge that connects the system bus 4319 and an Image Bus 4311 for transferring image data to the printer 300 to each other. A printer I/F 4316, an image compressor 4312, an image rotator 4313, and a raster image processor (RIP) 4314 are connected to the Image Bus 4311.

The image compressor 4312 performs compression and decompression processing for JPEG, JBIG, MMR, MH, and the like. The image rotator 4313 performs image rotation processing. The RIP 4314 expands PDL code into a bitmap raster image. The printer I/F 4316 transmits image data to the printer 300. This image data is generated by the controller 400 performing image processing for the printer 300, such as correction for the printer 300 and resolution conversion, on the image data for print output.

### Inspection Controller

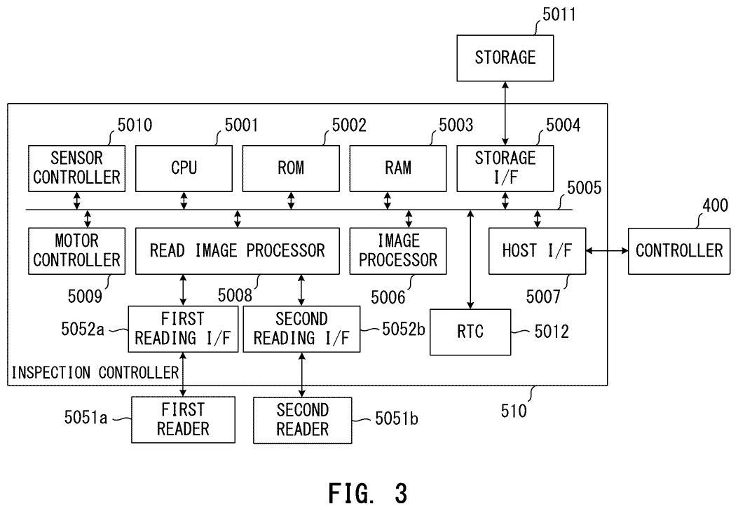

FIG. 3 is a configuration diagram of the inspection controller 510 provided to the inspection apparatus 500. The inspection controller 510 controls operations of the first reader 5051a and the second reader 5051b. The inspection controller 510 performs processing, such as analysis of the reading results from the first reader 5051a and the second reader 5051b, operation control of the inspection apparatus 500, and communication with the controller 400. Further, the inspection controller 510 is connected to a storage 5011, which is a storage unit for storing a misregistration correction profile and the like, and the controller 400.

The inspection controller 510 includes a CPU 5001, a ROM 5002, a RAM 5003, a storage I/F 5004, a motor controller 5009, a read image processor 5008, an image processor 5006, an RTC 5012, a host I/F 5007, and a sensor controller 5010. The respective components are connected to a system bus 5005. The read image processor 5008 is connected to the first reader 5051a through a first reading I/F 5052a, and is connected to the second reader 5051b through a second reading I/F 5052b. The RTC 5012 is a real-time clock, and holds the current time with high accuracy.

The host I/F 5007 controls communication with the inspector I/F 4317 of the controller 400. When the inspection controller 510 and the controller 400 communicate with each other, data is transmitted and received between the host I/F 5007 and the inspector I/F 4317. For example, the host I/F 5007 acquires image data used for an image forming operation of the printer 300 from the controller 400. The storage 5011 is a large-capacity storage device, such as an HDD or an SSD. The image data is stored in the storage 5011.

The CPU 5001 executes a computer program stored in the ROM 5002 to control the operation of the inspection apparatus 500. The RAM 5003 provides a work area for the CPU 5001 to execute processing. The storage I/F 5004 controls communication with the storage 5011 connected to the inspection controller 510.

The read image processor 5008 is controlled by the CPU 5001 to acquire the reading result of the image on the printed matter from the first reader 5051a through the first reading I/F 5052a. The read image processor 5008 is also controlled by the CPU 5001 to acquire the reading result of the image on the printed matter from the second reader 5051b through the second reading I/F 5052b. Under the control of the CPU 5001, the read image processor 5008 performs magnification processing, gamma correction processing, and the like on the reading results (read data) of the images on the printed matter, which have been acquired from the first reader 5051a and the second reader 5051b, to generate read image data, and stores the read image data in the RAM 5003. The first reader 5051a and the second reader 5051b are each provided with a sensor array, and are each capable of reading an entire region of the printed matter conveyed on the conveying path 501. The first reader 5051a reads an image on a first side of a printed matter, and the second reader 5051b reads an image on a second side of the printed matter.

The first reader 5051a and the second reader 5051b are each formed of a light emitter and a light receiver. The light emitter is formed of, for example, a white light emitting diode (LED), and the light receiver is formed of, for example, a CMOS sensor equipped with an RGB color filter. The light emitter is controlled by the CPU 5001 to irradiate the printed matter being conveyed along the conveying path 501 with light. The light receiver receives the light reflected from the printed matter while separating the light into three color components of RGB through use of a color filter, and outputs read data as a light reception result (reading result). The read data is transmitted to the read image processor 5008.

Under the control of the CPU 5001, the motor controller 5009 controls operations of various motors provided in the inspection apparatus 500. Under the control of the CPU 5001, the sensor controller 5010 controls the operations of various sensors provided in the inspection apparatus 500, and notifies the CPU 5001 of detection results from the sensors. The image processor 5006 is controlled by the CPU 5001 to compare the image data stored in the storage 5011 (hereinafter referred to as “reference image data”) to the read image data stored in the RAM 5003, to thereby perform a quality inspection of the printed matter. The reference image data is an image data used by the printer 300 forming an image, and is stored in the storage 5011. Alternatively, the reference image data may be an image obtained by reading a reference image in advance before the quality inspection is performed. During comparison, the image processor 5006 performs correction processing on the reference image data using parameters based on calibration be described later.

### Printing Settings

FIG. 4 is an explanatory view of the printing setting screen displayed on the display of the operating device 200 when the printer 300 is instructed to perform printing. A user inputs data using the printing setting screen displayed on the display to cause the printer 300 to execute printing. In FIG. 4, buttons B101 to B104 are buttons for setting contents of printing, such as color selection for printing (color/monochrome), selection of a surface to be printed (single-sided/double-sided), sheet type selection, and delivery selection of printed matter. In addition, the number of copies to be printed can be set through use of a numeric keypad (not shown). In a case where a button B105 serving as a printing start button or a button B106 serving as a test printing starting button is pressed, printing is started with the printing settings provided by the button B101 to the button B104 and the number of copies set by the numeric keypad. The inspection apparatus 500 executes the inspection of the printed matter in accordance with inspection settings provided in advance. The individually provided buttons B105 and B106 allows the inspection apparatus 500 to distinguish between the printing modes (main printing mode or test printing mode). The printing operation of the image forming apparatus is the same in both modes. In a case where a button B107, which is a cancel button, is pressed, the settings are canceled, and a predetermined initial screen is displayed on the display of the operating device 200.

### Inspection Settings

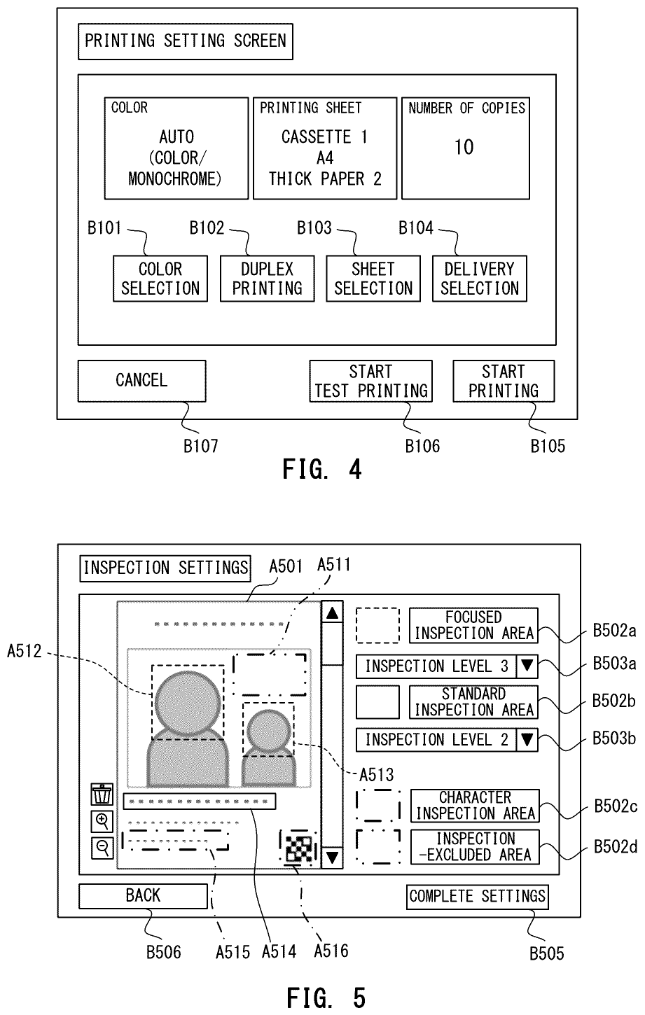

FIG. 5 is an explanatory view of an inspection setting screen for providing the inspection settings of the inspection apparatus 500. The inspection setting screen has a function serving as reception means for receiving an instruction from the user for setting an inspection area in which an inspection such as a quality inspection is to be executed by the inspection apparatus 500. In FIG. 5, an area A501 is an area for displaying a printing image and an inspection setting area. An original image in a print job is displayed in the area A501, and an area A511 to an area A516 are provided as inspection areas.

In FIG. 5, the user can set the inspection area by selecting one or more of the areas A511-A516 with one of inspection area type buttons, illustrated as the buttons B502a-B502d, being selected. Buttons B502a-B502d are buttons for indicating an inspection area type. In FIG. 5, the button B502a, which is a focused inspection area button for setting an area in which a highly accurate inspection is to be performed, and the button B502b, which is a standard inspection area button for setting an overall inspection level, are illustrated. Moreover, in FIG. 5, the button B502c for detailed settings related to variable inspection areas, and the button B502d, which is an inspection exclusion area button which specifies areas where inspection is not performed are illustrated. Thus, a total of four buttons are illustrated.

The buttons B503a and B503b are inspection setting buttons for setting, in order to set inspection accuracy stepwise, an inspection level for each inspection area type from a level 1 to a level 5, for example. The user can set up an inspection level for every area of the button B502a and the button B502b. In this example, an inspection level 1 has the lowest inspection accuracy, and the inspection accuracy increases as the inspection level number increases. A button B505 is a setting completion button, and when the user selects this button, the inspection settings are completed. A button B506 is a button for returning to the previous screen, and in a case where a machine operator selects this button, inspection setting processing is canceled to return to a predetermined initial screen.

For example, the user can freely select an area to be subjected to a high accuracy inspection by selecting the button B502a and selecting, using a mouse, a touch panel or the like, an area to which the high accuracy inspection is required to be performed. In the example in FIG. 5, a high accuracy inspection is performed on a person's face. In addition, as there is no need to carry out the high accuracy inspection of a background area, an inspection exclusion area is set to the background area. Therefore, as compared to a case where the entire image is inspected without the above selection, the amount of memory and processing power required for the inspection can be reduced. In addition, through setting of the inspection level stepwise, for example, from the level 1 to the level 5, the amount of memory and processing power required for the inspection can be reduced compared to a case of constantly performing the inspection at a high level of inspection accuracy.

### Printing Inspection During Test Printing

The test printing is used for checking whether or not the print image, the printing settings of the printer 300, and the inspection settings of the inspection apparatus 500 are correct. For example, there may be a case where a print image includes a character string and the user wishes to inspect whether or not the printed character string is correct through use of the inspection apparatus 500. In this case, it is necessary to set an area (hereinafter referred to as “inspection area”) where the inspection apparatus 500 identifies the character string by performing Optical Character Recognition (OCR) processing. However, in a case where the inspection area is not set correctly, the character string cannot be specified, thus the inspection result is NG (unacceptable). In a case where the inspection NG occurs during the execution of the test printing, the inspection apparatus 500 notifies, through an operation screen of a display of the operating device 200, the user to confirm that there is no error in the inspection settings.

### Setting Deletion Condition for Test Printing Inspection Result Data

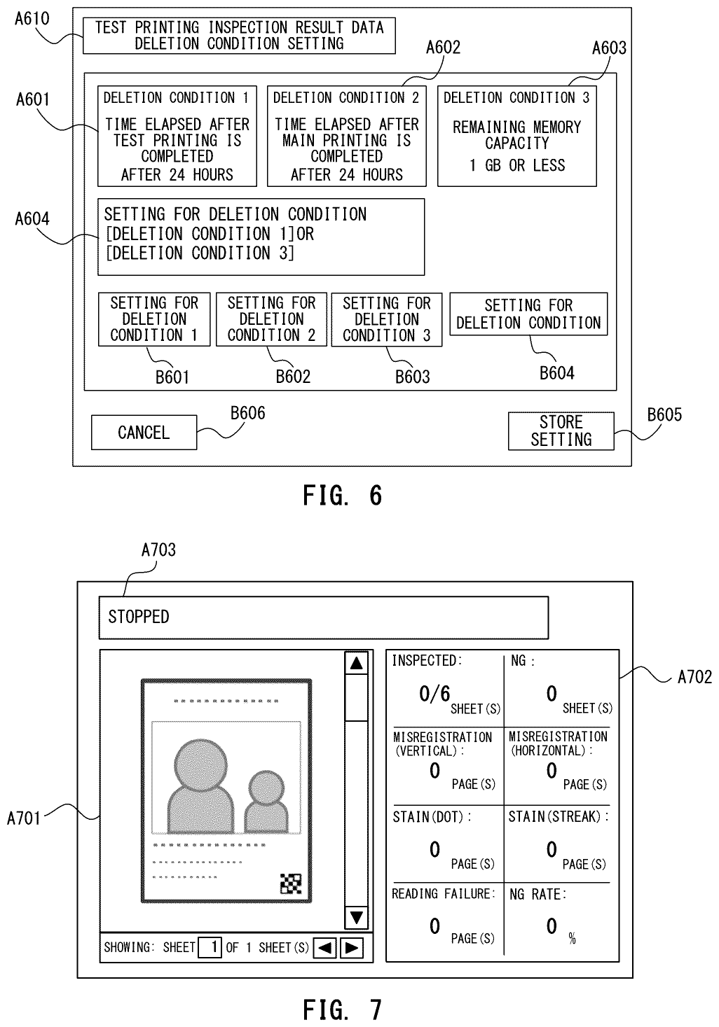

FIG. 6 is an explanatory view of a deletion setting screen for test printing inspection result data displayed on the display of the operation device 200. The user sets a deletion condition of test printing inspection result data using the deletion condition setting screen. The deletion condition is a condition for automatically deleting the inspection result data, and the inspection result data can be automatically deleted in a case where the deletion condition is met. In an area A610, an explanation “TEST PRINTING INSPECTION RESULT DATA DELETION CONDITION SETTING” is displayed. In areas A601 to A604, contents set for deletion conditions 1 to 3 are displayed respectively. By pressing a button B604, the user can set the conditions to be applied.

Buttons B601, B602, and B603 are buttons for setting the contents of deletion conditions 1, 2, and 3, respectively, and the button B604 is a button for setting the deletion conditions. The user can select one or more of “deletion condition 1: time elapsed after test printing is completed”, “deletion condition 2: time elapsed after main printing is completed”, and “deletion condition 3: remaining memory capacity”. To set the time elapsed for deletion condition 1, the user presses the button B601 and enters a numerical value for the time elapsed. To set the time elapsed for deletion condition 2, the user presses the button B602 and enters a numerical value for the time elapsed. To set the remaining memory amount for deletion condition 3, the user presses the button B603 and enters a numerical value for the remaining memory. To set the deletion conditions, the user presses the button B604 and enters one or any combination of the deletion conditions 1 to 3. Thus, the deletion condition (or a combination of deletion conditions) set by the user is displayed in the area A604. These deletion conditions 1 to 3 can be set individually or in any combination of “AND” and “OR” conditions. In the area A604 in FIG. 6, an example in which “OR” condition is set between the deletion condition 1 and the deletion condition 3 is shown.

In the example of FIG. 6, as to the deletion condition 1, the user has entered “after 24 hours” for the time elapsed after completion of the test print, and, as to the deletion condition 2, the user has entered “after 24 hours” for the time elapsed after completion of the main printing. As to the deletion condition 3, the user has entered “1 GB or less”, which is the number of remaining free memory amount of the storage 5011, for the remaining memory capacity. Although the time elapsed after completion of the test print is set in the deletion condition 1, the time elapsed after storing the inspection result data in the storage 5011 in the test printing may be set in the deletion condition 1, alternatively. Although the time elapsed after completion of the main printing is set in the deletion condition 2, the time elapsed after storing the inspection result data in the storage 5011 in the main printing may be set in the deletion condition 2, alternatively. The button B605 is a button for storing settings, and by pressing this button, the settings displayed on the display are stored and applied. The button B606 is a cancel button, and by pressing this button, the settings are not stored and the processing for setting a deletion condition is ended.

### Description of Inspection Execution Screen of Operating Device

FIG. 7 is an explanatory view of the operation screen of the operation device 200 during execution of an inspection. In FIG. 7, an area A701 is an area for displaying a read image. An area A702 is an area for displaying inspection statuses, such as a completed inspection count, an inspection NG count, an inspection NG rate, and a type of NG. An area A703 is an area for displaying a status of the printer 300, such as waiting, inspecting, or inspection completed. In FIG. 7, “STOPPED” is displayed in the area A703 to indicate that the printer 300 is temporarily stopped.

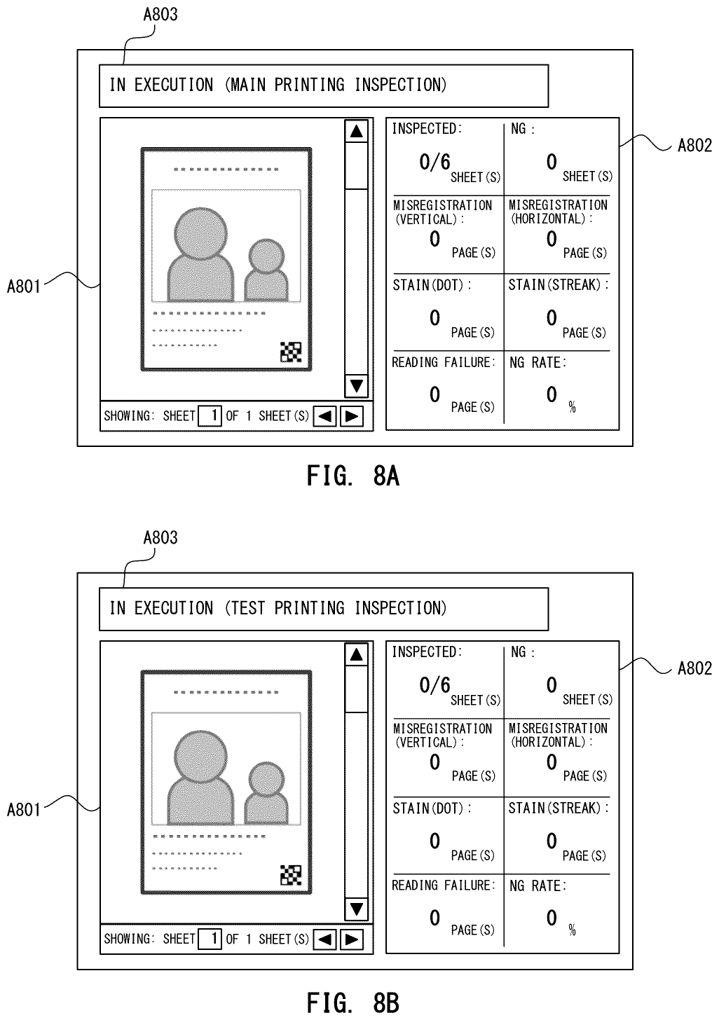

FIG. 8A is an explanatory view of the operation screen of the operation device 200 displayed when the printer 300 is executing a main printing inspection, and FIG. 8B is an explanatory view of the operation screen displayed when the printer 300 is executing a test printing inspection. In these figures, an area A801 is an area for displaying a read image, an area A802 is an area for displaying inspection statuses, such as a completed inspection count, an inspection NG count, an inspection NG rate, and a type of NG. An area A803 is an area for displaying a status, such as waiting, inspecting, or inspection completed. In a case where the printer 300 has executed the main printing and the inspection apparatus 500 is executing an inspection, as illustrated in FIG. 8A, a content which indicates that the main printing inspection is being executed is displayed in the area A803. In a case where the printer 300 has executed the test printing and the inspection apparatus 500 is executing an inspection, as illustrated in FIG. 8B, a content which indicates that the test printing inspection is being executed is displayed in the area A803. As described above, the user can easily check whether the inspection is the test printing inspection or the main printing inspection, by checking the content displayed in the area A803 of the operation screen during execution of an inspection.

### Main Printing Inspection Processing Flow

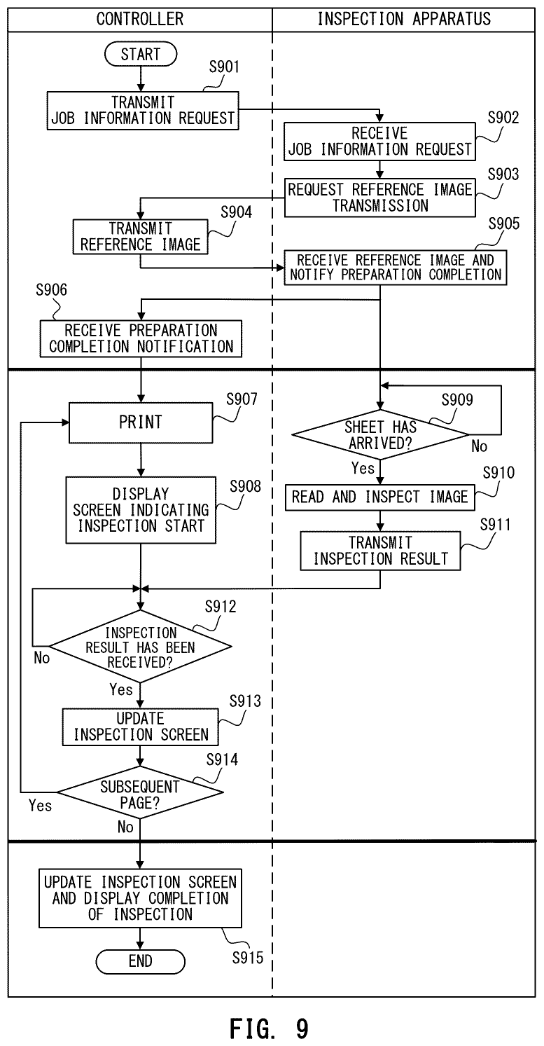

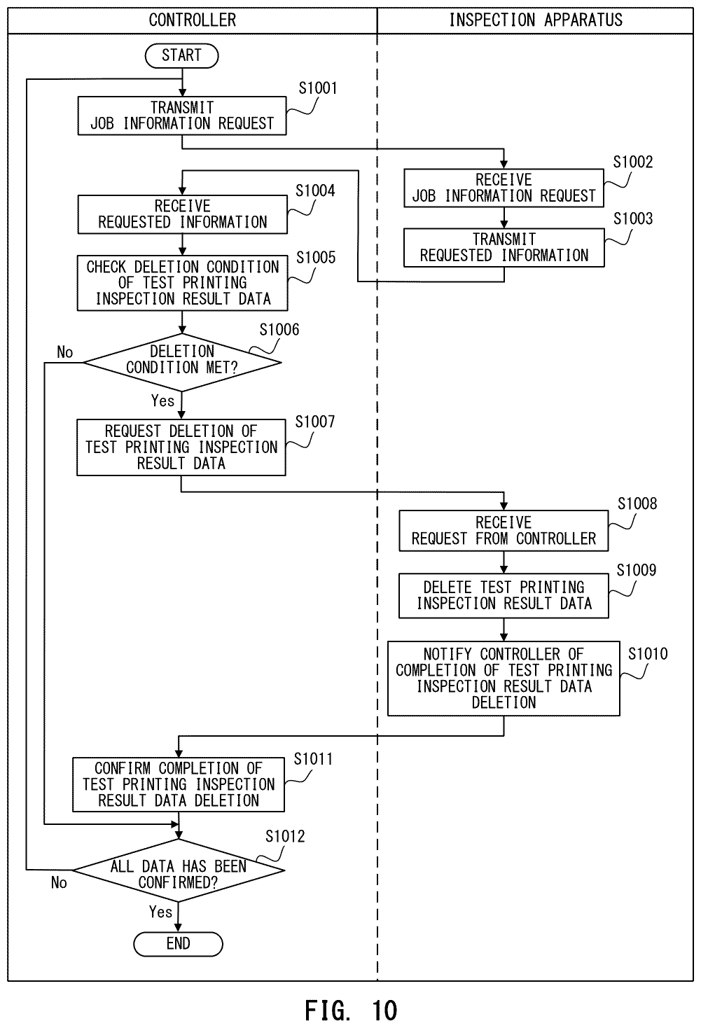

FIG. 9 is a flowchart representing an inspection printing process in the present embodiment. In this flow chart, the processing to be executed by the CPU 4301 of the controller 400 and the processing to be executed by the CPU 5001 of the inspection apparatus 500 are collectively illustrated. Moreover, this inspection printing process is used commonly in both of the main printing and the test printing. The inspection printing process is executed in a case where the user selects the button B105 for printing start or the button B106 for test printing start on the print setting screen illustrated in FIG. 4. In a case where the print start button B105 for printing start is selected on the operation screen of the operation device 200, the CPU 4301 sends job information, including sheet information used in the printing, inspection settings, and a destination of the sheet, to the inspection apparatus 500 (Step S901). The CPU 5001 receives the job information from the controller 400 (Step S902). After receiving a response to the job information from the controller 400, the CPU 5001 transmits, to the controller 400, a transmission request for a reference image, which is used as a reference for the inspection, for inspection determination (Step S903).

The CPU 4301 transmits original image data of the print job as reference image data to the inspection apparatus 500 based on the reference image transmission request received from the inspection apparatus 500 (Step S904). The CPU 5001 receives the reference image from the controller 400 to store the reference image in the storage 5011, and notifies the controller 400 of completion of preparation (Step S905). In a case where the CPU 4301 receives a preparation completion notification from the inspection apparatus 500 (Step S906), the CPU 4301 controls the printer 300 to start the printing (Step S907). After that, the CPU 4301 controls the operating device 200 to display a screen indicating that the inspection of the printed matter is started on the inspection screen (Step S908).

The CPU 5001 uses the sheet detection sensor 504 to determine whether or not the sheet has reached the conveying path 501 of the inspection apparatus 500 (Step S909), and, in a case where the sheet has not reached the conveying path 501 (Step S909: No), the determination in the Step S909 is repeated until the sheet is conveyed. When a sheet has reached (Step S909: Yes), the CPU 5001 reads the conveyed sheet by the first reader 5051a and the second reader 5051b, and instructs the image processor 5006 to perform processing for comparison to the reference image data received in Step S905. As a result, the image processor 5006 performs comparison processing and the image inspection is performed (Step S910). The CPU 5001 transmits an inspection result based on the comparison performed by the image processor 5006 to the controller 400 to store it in the storage 5011 (Step S911).

The CPU 4301 determines whether or not the inspection result has been received (Step S912), and if the inspection result has not received (Step S912: No), the determination processing in Step S912 is repeated. In a case where the CPU 4301 has received the inspection results (Step S912: Yes), the CPU 4301 controls the operation device 200 to update the inspection screen according to the inspection result (Step S913). After that, the CPU 4301 determines whether there is a next page (Step S914), and if there is a next page (Step S914: Yes), the CPU 4301 executes processing of Step S907 again. In a case where the printing and the inspection of all pages have been completed, that is, there is no next page (Step S914: No), the CPU 4301 controls the operation device 200 to display that the inspection has been completed on the inspection screen (Step S915). Thus, the inspection printing process is completed.

### Inspection Result Data Deletion Flow

FIG. 10 is a flow chart representing a deletion process to delete the inspection result data in the present embodiment. In this flow chart, the processing to be executed by the CPU 4301 of the controller 400 and the processing to be executed by the CPU 5001 of the inspection apparatus 500 are collectively illustrated. The process is performed by the CPU 4301 at regular intervals regardless of user operation. The CPU 4301 transmits a request to the CPU 5001 to transmit information about results of one test printing inspection (Step S1001). In this example, the following four pieces of information were used as information related to the test printing inspection result data: “date and time information for test printing inspection”; “date and time information for main printing corresponding to test printing inspection”; “remaining memory capacity available for storing inspection result data”; and “deletion condition set for test printing inspection result”. However, it is also possible to use other information in addition to these.

The CPU 5001 receives the request to transmit the information from the controller 400 (Step S1002) and transmits the requested information to the CPU 4301 (Step S1003). In this example, the CPU 5001 transmits the four pieces of information described above. The CPU 4301 receives the requested information (Step S1004), checks whether the deletion condition of the test printing inspection result data is satisfied (Step S1005), and determines whether or not the deletion condition is met (Step S1006). In a case where the deletion condition is not met (Step S1006: No), the CPU 4301 executes the process of Step S1012 described below. In a case where the deletion condition is met (Step S1006: Yes), the CPU 4301 transmits a request to the CPU 5001 to delete the test printing inspection result data (Step S1007).

The CPU 5001 receives the deletion request from the CPU 4301 (Step S1008), deletes the test printing inspection result data stored in the storage 5011 (Step S1009), and notifies the CPU 4301 that the test printing inspection result data has been deleted (Step S1010). In this way, the inspection results for which the deletion conditions are met are selectively deleted. In addition, this deletion is done automatically. The CPU 4301 receives the notification from the CPU 5001 of the inspection apparatus 500 and confirms that the test printing inspection result data has been deleted (Step S1011). Thereafter, the CPU 4301 determines whether or not all of the test printing inspection result data has been confirmed (Step S1012). In a case where there remains an unconfirmed test printing inspection result data (Step S1012: No), the CPU 4301 executes Step S1011 again. In a case where all of the test printing inspection result data has been confirmed (Step S1012: Yes), the deletion process to delete the inspection result data is completed. By performing the deletion process to delete the inspection result data as described above, the user can selectively delete the inspection results for which the deletion conditions are met, thus, reduction of the memory amount for storing the inspection result data is suppressed. Thus, the user can comfortably perform print inspections.

Furthermore, in a case where the test printing inspection result data satisfies the deletion condition in Step S1006, the CPU 4301 may control the display of the operation device 200 to indicate that there is an inspection result that satisfies the deletion condition. In this case, even if the deletion condition is met, the search result data is not automatically deleted. The CPU 4301 displays a screen on the display of the operation device 200 for prompting the user to approve the deletion of the inspection result data to suspend the process to delete the inspection result data, thereby Step S1007 and subsequent steps are not performed. Furthermore, a screen that allows the user to select whether to continue or cancel the deletion process to delete the inspection result data is displayed on the display of the operation device 200, and after the user selects to continue the process, the deletion process to delete the inspection result data is continued. In a case where the user selects to cancel the process, the deletion process to delete the inspection result data is cancelled. In this case, the user can ensure free memory amount in the storage 5011 by deleting data other than the inspection result data, for example, the reference image data or the like.

In addition, the deletion process to delete the inspection result data described above can also be used together with other data deletion process. For example, it is possible to use a data deletion process, together with the above process to delete the inspection result data, that deletes old data regardless of the type of data (e.g. whether it is the inspection result or the reference image data) in a case where the occupied memory capacity exceeds a certain amount. On the other hand, by performing the above described process to delete inspection result data, it is possible to delete the inspection result data that meets the deletion conditions as data with a low priority for data storage, and allowing other data with a high priority to remain in the memory.

Alternatively, in addition to deleting the inspection result data, it is also possible to delete the reference image data stored in storage 5011 in conjunction with the process to delete the inspection result data. In this case, the priority for data storage of the reference image data is determined using any suitable methods, and reference image data with a priority lower than a predetermined standard is deleted from storage 5011. In addition, when performing an inspection such as the main printing inspection or the test printing inspection, the reference image data used in the inspection may be associated with the inspection result data for the inspection. Furthermore, as to the reference image data associated with the inspection result data that has been determined to be deleted in the above process to delete the inspection result data, it is treated as a candidate for deletion from storage 5011, and the priority for maintaining it in data storage may be lowered. Because it can be determined that the necessity of the reference image data used in the inspection may also tend to decrease in a case where the inspection result data is deleted.

Thus, the reference image data that is associated with the deleted inspection result data can be deleted with high priority. Furthermore, as to the reference image data that is associated with multiple sets of inspection result data, it may not be selected as a candidate for deletion, or the priority for storing in a data storage may be increased. This is because the more the number of inspection result data that is associated with the reference image data, the more likely it is that the reference image data is necessary. With this configuration, it is possible to perform a process to delete the reference image data together as a result of the process to delete the inspection result data. According to the present disclosure, it is possible to prevent problems occurring in the printing inspection due to insufficient free memory amount for storing the inspection result data.

The present disclosure is only an example, and various modifications and revisions are possible. For example, in FIG. 9, Steps S901, S904, S906 to S909, and Steps S912 to S915 are described as processes performed by the controller, and Steps S902, S903, S905, and Steps S909 to S911 are described as processes performed by the inspection apparatus. However, it is also possible to use a configuration in which one or more of the processes carried out by the controller in FIG. 9 are carried out by the inspection apparatus. Alternatively, it is possible to use a configuration in which one or more of the processes carried out by the inspection apparatus are carried out by the controller. The same applies to the processes in FIG. 10.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-211222, filed Dec. 14, 2023, which is hereby incorporated by reference herein in its entirety.

What is claimed is:

1. An inspection apparatus, comprising:
an inspection unit configured to inspect an image formed on a sheet;
a memory configured to store an inspection result inspected by the inspection unit; and
a setting unit configured to set a condition for automatically deleting the inspection result.

2. The inspection apparatus according to claim 1,
wherein, in a case where a deletion condition set for automatically deleting the inspection result is met, the setting unit is configured to request, for a deletion unit configured to delete the inspection result from the memory, to delete the inspection result from the memory.

3. The inspection apparatus according to claim 1, further comprising a receiving unit configured to receive an operation from a user,
wherein the condition for automatically deleting the inspection result is settable through the receiving unit.

4. The inspection apparatus according to claim 1, further comprising a control unit configured to determine, as to the inspection result stored in the memory, whether or not the condition for automatically deleting the inspection result is met at predetermined intervals.

5. The inspection apparatus according to claim 1,
wherein the inspection unit is operable to perform inspection of test printing, and
wherein the condition for automatically deleting the inspection result comprises a time elapsed after completion of the test printing.

6. The inspection apparatus according to claim 1,
wherein the inspection unit is operable to perform inspection of main printing, and
wherein the condition for automatically deleting the inspection result comprises a time elapsed after completion of the main printing.

7. The inspection apparatus according to claim 1, further comprising a control unit configured to delete the inspection result such that older inspection result is deleted with higher priority in a case where the condition for automatically deleting the inspection result is met by two or more inspection results.

8. The inspection apparatus according to claim 7,
wherein the inspection unit is operable to perform the inspection of main printing and the inspection of the test printing, and
wherein the control unit is configured to delete the inspection result of the test printing with high priority in a case where both the inspection result of the main printing and the inspection result of the test printing that is newer than the main printing meets the conditions for automatically deleting the inspection results.

9. The inspection apparatus according to claim 1,
wherein the condition for automatically deleting the inspection result comprises a remaining free memory amount of the memory.

10. The inspection apparatus according to claim 1, further comprising:
a display unit; and
a control unit configured to suspend, in a case where there is an inspection result that satisfies the condition for automatically deleting the inspection result, a process of deleting the inspection result and control the display unit to indicate that there is an inspection result that satisfies the condition for automatically deleting the inspection result.

11. The inspection apparatus according to claim 10,
wherein the control unit is further configured to control the display unit to display a screen that allow selection to continue or cancel the process of deleting the inspection results that satisfies the condition for automatically deleting the inspection result.

12. The inspection apparatus according to claim 1,
wherein inspection is performed using a reference image, which is used as a reference for the inspection, stored in the memory,
wherein the reference image is associated with the inspection result, and
further comprising a control unit configured to select, as a candidate for deletion from the memory, the reference image that is associated with the inspection result that satisfies the condition for automatically deleting the inspection result.

13. The inspection apparatus according to claim 12,
wherein the control unit is configured to not select, in a case where there are two or more inspection result data associated with the reference image, the reference image as the candidate for deletion from the memory.

14. An image forming apparatus comprising:
an image forming unit configured to form an image on a sheet based on image data;
an inspection unit configured to inspect an image formed on a sheet;
a memory configured to store an inspection result inspected by the inspection unit; and
a controller configured to execute main printing for controlling the image forming unit to form an image based on the image data, or test printing for controlling the image forming unit to form an image based on only a part of the image data,
wherein a first inspection result obtained by performing the test printing is automatically deleted, and a second inspection result obtained by performing the main printing is not automatically deleted.

15. The image forming apparatus according to claim 14, further comprising a receiving unit configured to receive an operation from a user,
wherein a condition for automatically deleting the inspection result is settable through the receiving unit.

16. The image forming apparatus according to claim 14,
wherein, as to the inspection result stored in the memory, it is determined whether or not a condition for automatically deleting the inspection result is met at predetermined intervals.

17. The image forming apparatus according to claim 14,
wherein a condition for automatically deleting the inspection result comprises a time elapsed after completion of the test printing.

18. The image forming apparatus according to claim 14,
wherein the inspection result is deleted such that older inspection result is deleted with higher priority in a case where a condition for automatically deleting the inspection result is met by two or more inspection results.

19. The image forming apparatus according to claim 14,
wherein the inspection result of the test printing is deleted with high priority in a case where both the inspection result of the main printing and the inspection result of the test printing that is newer than the main printing meets the conditions for automatically deleting the inspection results.

20. The image forming apparatus according to claim 14,
wherein a condition for automatically deleting the inspection result comprises a remaining free memory amount of the memory.

21. The image forming apparatus according to claim 14, further comprising a display unit, and
wherein, in a case where there is an inspection result that satisfies a condition for automatically deleting the inspection result, a process of automatically deleting the inspection result is suspended, and the display unit is controlled to indicate that there is an inspection result that satisfies the condition for automatically deleting the inspection result.

22. The image forming apparatus according to claim 14, further comprising a display unit, and
wherein the display unit is controlled to display a screen that allow selection to continue or cancel a process of deleting the inspection results that satisfies the condition for automatically deleting the inspection result.

23. The image forming apparatus according to claim 14,
wherein the inspection is performed using a reference image, which is used as a reference for the inspection, stored in the memory,
wherein the reference image is associated with the inspection result, and
wherein the reference image that is associated with the inspection result that satisfies condition for deleting the inspection result is selected as a candidate for deletion from the memory.

24. The image forming apparatus according to claim 23,
wherein, in a case where there are two or more inspection result data associated with the reference image, the reference image is not selected as the candidate for deletion from the memory.
